(19) United States
(12) Patent Application Publication
(10) Pub. No.: US 2015/0258587 A1
(43) Pub. Date: Sep. 17, 2015

(54) System and method for deep cleaning water ionizers

(71) Applicant: Cleveland W. Alleyne, Glendale, CA (US)

(72) Inventor: Cleveland W. Alleyne, Glendale, CA (US)

(21) Appl. No.: 13/999,702

(22) Filed: Mar. 15, 2014

(51) Int. Cl. B08B 9/08; C02F 1/461

(52) U.S. Cl. CPC B08B 9/0856; C02F 1/4618

(57) ABSTRACT

A device, system and method of cleaning water ionizers. Allowing for regular end user fluid stream deep cleaning of water Ionizer internal components. Particularly metal surface known as Ionization plates or mesh plates. Water ionization plates typically accumulate water scale from prolonged contact with water passing over the plate surface during the ionization process.

The present invention facilitates a pressurized streaming method of dissolving water scale buildup accumulated over time on internal parts of water Ionizer systems. Specifically, the ionization plates, typically some form of metal. i.e., medical grade titanium and or mesh plates materials found in water ionizers.

This application claims priority from U.S. Provisional Application No. 61/852,563 filed Mar. 15, 2013.

### BACKGROUND OF THE INVENTION

1. Field of the Invention

The present invention relates to a system and method for deep cleaning water ionizers. More particularly, but not by way of limitation, the invention relates to an apparatus for recirculating cleaning solutions through a water ionizer for the purpose of cleaning/descaling internal parts of a water ionizers.

2. Background of the Invention

Water ionizers are devices that restructure water, by first filtering out impurities like chlorine and other contaminants via a filter. The water is then passed through an ionization chamber, consisting of medical grade titanium plate material impregnated with a platinum coating. As water passes over this plate and or mesh material, the plate is given a mild electrical charge. This electrical charge performs a restructuring of the water, adding properties of alkalinity, micro clustering, (a smaller water molecule), then finally separating/splitting the water into two streams: a positive stream and a negative stream. The positive of this split being acidic, the negative being the equivalent of an antioxidant or hexagonal water.

Unfortunately, outside of recommended yearly factory servicing, water ionizers lack a robust user-friendly option for regular end user deep cleaning. Currently the majority of water ionizer brands on the market claim to be self-cleaning; this is a cleaning mode where mild acidic water is periodically generated by the ionizer, and passed through the system to clean the ionization plate/mesh chamber's water scale buildup. In another scenario the filter is removed and replaced with a blank cartridge and a specified measure of food grade citric acid powder. The ionizer is then filled with water to dissolve the citric acid inside the ionizer, it is then allowed to soak for a prescribed period of time. However, this fill and soak cleaning method is the equivalent of putting clothes in a washing machine with detergent and no agitation. This process does not employ recirculation of the cleaning solution. The fill and soak method diminishes the ability of the cleaning solution to remove water scale as well as intended.

### SUMMARY OF THE INVENTION

The present invention provides a method for re-circulative deep cleaning of a water ionizer with a convenient one-piece submersible pump reservoir device. The inventive device enables the end user to perform end user initiated cleaning of water ionizers by recirculating cleaning solution back and forth between the water ionizer and the inventive device. Cleaning solution is pumped into the water ionizer's main water supply line, while output water hoses from the water ionizer is pointed into the inventive device's fluid containment reservoir for recirculation, thus allowing for continuous recycling of cleaning solution, providing a method of active stream deep cleaning.

In one preferred embodiment the inventive cleaning system is attached to a water ionizer, propelling a cleaning solution from the inventive device into the water inlet line of a water ionizer for the purpose of deep cleaning the water ionizers internal parts.

### BRIEF DESCRIPTION OF THE DRAWINGS

FIG. 1 depicts the components of the inventive cleaning system.

FIG. 2 provides a cutaway view of the system of FIG. 1.

FIG. 3 depicts the system of FIG. 1 attached to a water ionizer.

### DESCRIPTION OF THE PREFERRED EMBODIMENTS

Before explaining the present invention in detail, it is important to understand that the invention is not limited in its application to the details of the construction illustrated and the steps described herein. The invention is capable of other embodiments and of being practiced or carried out in a variety of ways. It is to be understood that the phraseology and terminology employed herein is for the purpose of description and not of limitation.

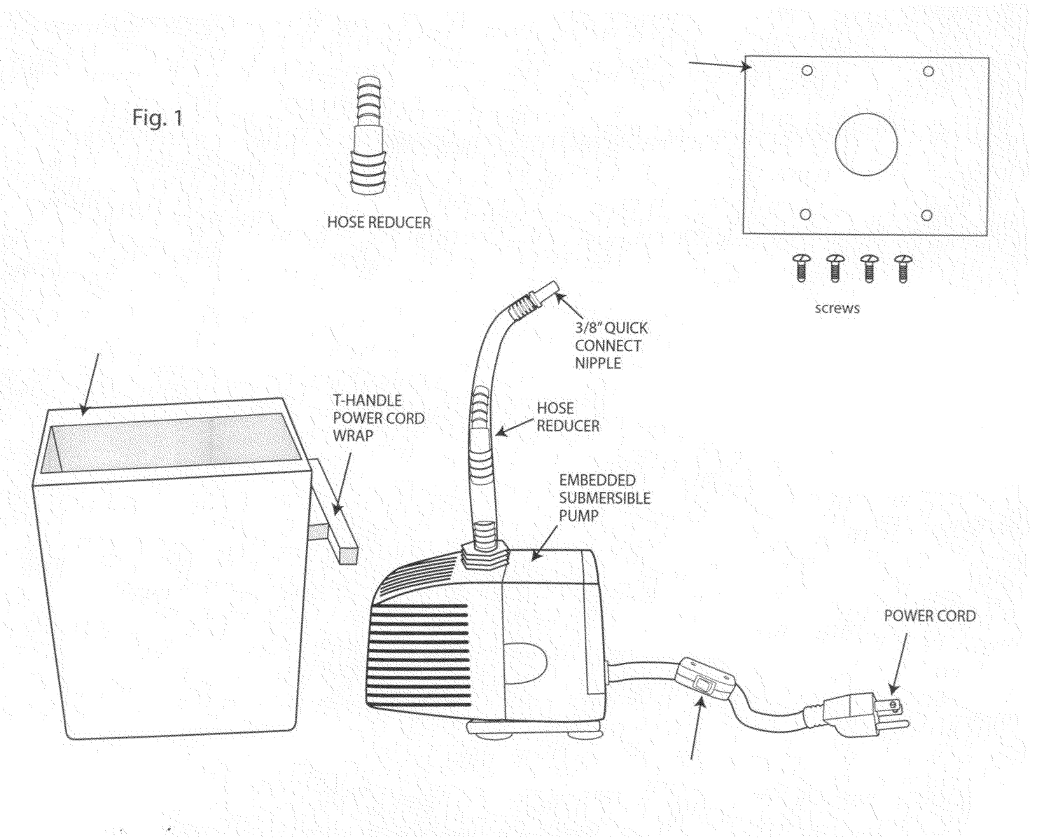

FIG. 1 shows the various components of one preferred embodiment of the inventive deep cleaning system 100 for a water ionizer. Such ionizers are well known in the art. Embodiment 100 includes: acrylic containment tank 180; submersible pump 101; and retainer plate 182.

Containment tank 180 includes T-handle 110. Preferably tank 180 is constructed water-tight so as to contain a cleaning solution as will be discussed in more detail below.

Pump 101 include: power cord 102 having a conventional power plug 104 at one end for connection to household power; an on/off switch 103 for activating and deactivating pump 101; an induction inlet 186 for receiving cleaning fluid during a cleaning process; and outlet 184 for discharging the pumped cleaning fluid; and an outlet hose 114 for conveying the cleaning fluid to a water ionizer during the cleaning process. If outlet 184 is not sized the same as the cleaning port on a particular ionizer, adapters may be added in line to accommodate the change in size. Thus, by way of example and not limitation, hose 188 includes reducer 109, hose extension 105, quick connect nipple 106.

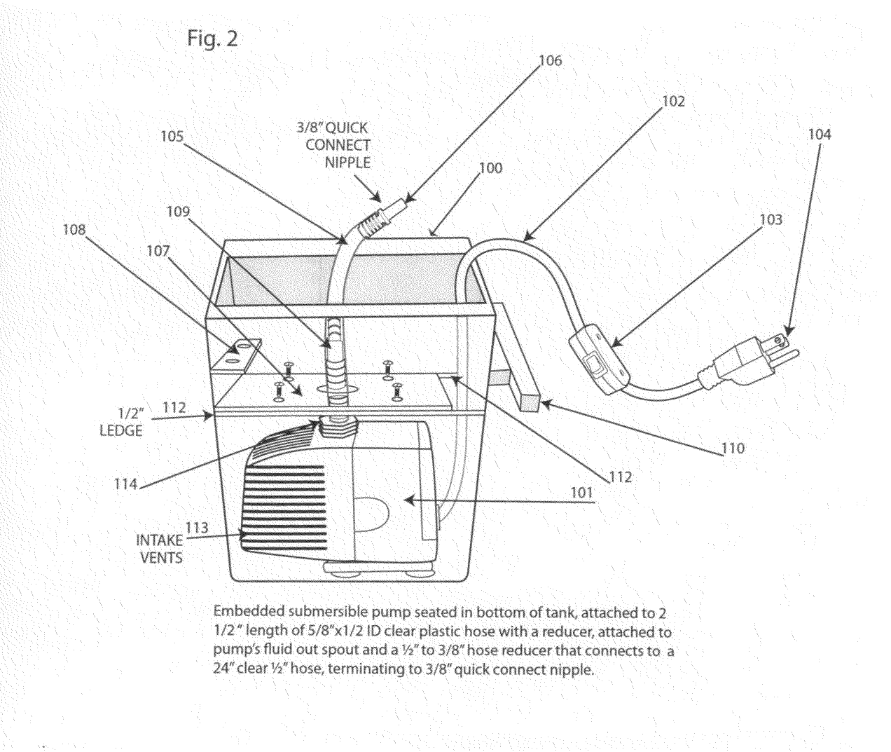

With further reference to FIG. 2, inventive cleaning system 100 is assembled by placing submersible pump 101 in tank 180. Next, outlet hose 188 is fed through hole 190 in retaining plate 182. Retaining plate is then secured to ledges 112 of tank 180 with screws 107 (4 places) by first inserting the screws in holes 192 (4 places) of plate 182. Cord 102 is threaded routed past plate 182 and over the top of reservoir 180. T-handle 110 can double as a cord wrap for cord 102 during transportation of the cleaning system or storage.

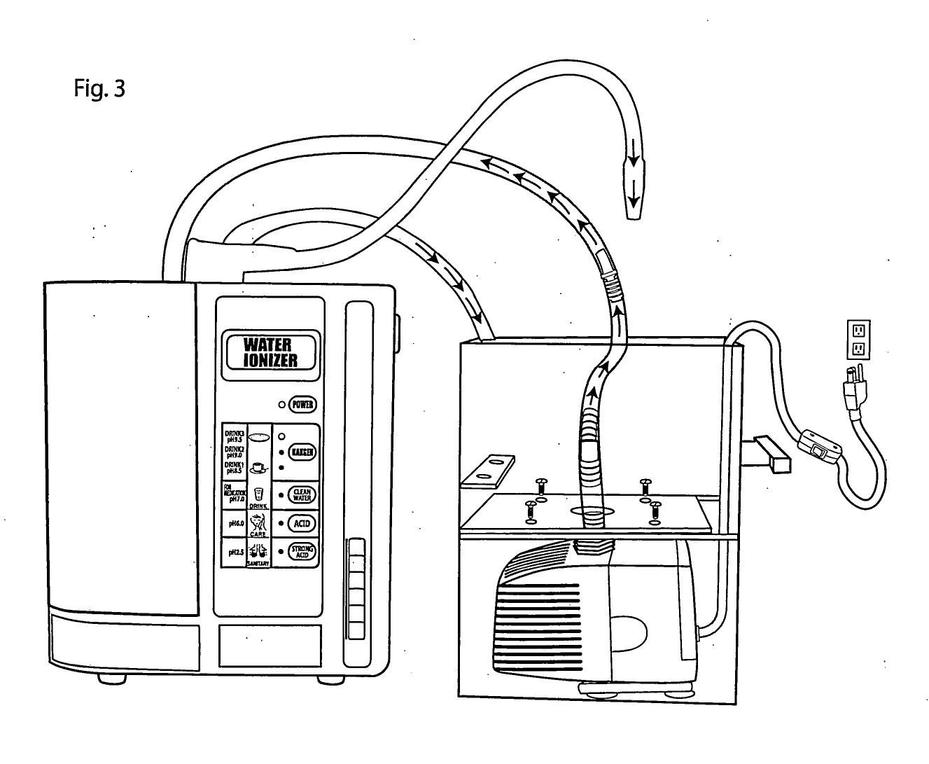

Turning to FIG. 3, to clean a water ionizer 300, reservoir is first filled with a suitable cleaning fluid. By way of examples and not limitation, one such fluid is citric acid powder mixed with water in roughly a specified ratio. Next, hose 302 is connected to quick connect nipple 106, water inlet of ionizer 300. Outlet hoses 304 and 306 of ionizer 300 are routed so returning cleaning fluid will be returned to reservoir 180. Optionally, hoses 304 and 306 can be routed through the holes in hose holder 108 to prevent the hoses from inadvertently coming out of tank 180 and spilling the cleaning fluid. Pump 101 is then connected to a conventional electrical outlet 194 via plug 104 and turned on with switch 103. This causes cleaning fluid to pass through 302 and fill the ionizer. Cleaning solution fills the ionizer chamber and begins to exit 304 and 306 recirculating back into the reservoir 180 (as shown by the arrows of FIG. 3) back and forth through ionizer 300. While cleaning times may vary based on the particular model of ionizer, the rate of flow of the cleaning solution, the period between cleanings, etc., in the preferred embodiment typically circulating the fluid for 6 to 8 hours provides a thorough deep cleaning.

Various features of the preferred embodiment are simply based on everyday engineering choices and the invention is not so limited. By way of example and not limitation, switch 103 is shown as a cord mounted switch, obviously it is immaterial to the invention where the switch is located. Additionally, the invention is shown and described as employing a submersible pump but the invention is not so limited.

Thus, the present invention is well adapted to carry out the objects and attain the ends and advantages mentioned above as well as those inherent therein. While presently preferred embodiments have been described for purposes of this disclosure, numerous changes and modifications will be apparent to those skilled in the art. Such changes and modifications are encompassed within the scope and spirit of this invention.

What is claimed is:

1. A deep cleaning system for a water ionizer comprising:
a reservoir for holding a cleaning fluid;
a pump having an inlet and an outlet, said inlet submerged in said reservoir; and
a first hose connected to said outlet for connection to an inlet of the water ionizer,
wherein said water ionizer includes two outlet hose and wherein said reservoir is configured to receive said outlet hoses such that, when said pump is activated, cleaning fluid will be conveyed from said reservoir through the water ionizer and back to said reservoir.

2. The cleaning system of claim 1 wherein said pump is a submersible pump and located within said reservoir.

3. The cleaning system of claim 2 further comprising a retainer to secure said submersible pump in said reservoir.

4. The cleaning system of claim 1 further comprising a hose holder secured in said reservoir for receiving the outlet hoses from the water ionizer.

5. A method for deep cleaning a water ionizer including the steps of:
a. providing a reservoir for receiving cleaning fluid;
b. providing a pump having an inlet and an outlet;
c. placing said pump (submersible) inlet in said reservoir;
d. placing said pump outlet in fluid communication with an inlet of the water ionizer;
e. routing outlet hoses of said ionizer to said reservoir;
f. putting and diluting cleaning fluid/powder in said reservoir;
g. activating said pump to circulate said cleaning fluid through the water ionizer.
